(19) United States
(12) Patent Application Publication
(10) Pub. No.: US 2025/0383668 A1
(43) Pub. Date: Dec. 18, 2025

(54) AUTONOMOUS VEHICLE, AUTONOMOUS SYSTEM INCLUDING THE SAME AND METHOD FOR AUTONOMOUS DRIVING USING THE SAME

(71) Applicant: HL MANDO CORPORATION, Pyeongtaek-si (KR)

(72) Inventors: Ingu CHOI, Pyeongtaek-si (KR); Junwoo KANG, Pyeongtaek-si (KR); Jaemin SHIN, Pyeongtaek-si (KR); Sangjin KO, Pyeongtaek-si (KR)

(73) Assignee: HL MANDO CORPORATION, Pyeongtaek-si (KR)

(21) Appl. No.: 19/063,752

(22) Filed: Feb. 26, 2025

(30) Foreign Application Priority Data
Jun. 14, 2024 (KR) 10-2024-0077360

(51) Int. Cl. G05D 1/646; G05D 1/246; G05D 109/10; G05D 111/10; G05D 111/50

(52) U.S. Cl. CPC G05D 1/646; G05D 1/2464; G05D 2109/10; G05D 2111/17; G05D 2111/52

(57) ABSTRACT

An autonomous vehicle according to an embodiment of the present disclosure includes: a driver to control driving of the autonomous vehicle; a sensor to obtain traveling information; and a processor to: identify a current location of the autonomous vehicle, based on the traveling information and a 3-dimensional first point cloud map of a target area, determine a 2-dimensional global path, which is from the current location to a destination location of the autonomous vehicle, based on a 2.5-dimensional first occupancy grid map, which indicates a global traversability, generate a 2.5-dimensional second occupancy grid map, which indicates a local traversability that is determined based on a second point cloud map obtained in real-time according to the traveling information, and control the driver by applying a 2-dimensional local path from the current location to the destination location, to the 2-dimensional global path, based on the second occupancy grid map.

### CROSS-REFERENCE TO RELATED APPLICATION

This application claims priority to and the benefit of Korean Patent Application No. 10-2024-0077360, filed on Jun. 14, 2024, the disclosures of which is incorporated herein by reference in its entirety.

### TECHNICAL FIELD

The present disclosure relates to an autonomous vehicle, an autonomous system including the same, and a method for autonomous traveling using the same.

### RELATED ART

Recently, autonomous traveling technology has greatly developed, and autonomous vehicles such as autonomous robots can move on their own without human intervention. In particular, the autonomous traveling technology is used in various fields such as robot cleaners and serving robots, but due to the characteristics of the usage environment, the focus is on the function of performing autonomous traveling indoors.

In order for the autonomous vehicles to travel in an outdoor environment, there is a limit to the existing indoor autonomous traveling method. For example, since the autonomous travels use only 2-dimensional information that does not reflect height information when traveling in indoors, the existing indoor autonomous traveling method is not suitable for various high and low outdoor environments. In addition, there is a limitation that positioning accuracy is somewhat lower when autonomous traveling in the outdoor based on the global navigation satellite system (GNSS).

Therefore, it is necessary to design a framework for the autonomous vehicles that can smoothly perform autonomous traveling even outdoors by reflecting height information.

### SUMMARY

The purpose of the present disclosure is to provide an autonomous vehicle capable of smoothly performing autonomous traveling even outdoors, an autonomous system including the same, and a method for autonomous traveling using the same.

In an autonomous vehicle according to an embodiment of the present disclosure, there is provided a driver configured to control driving of the autonomous vehicle; a sensor configured to obtain traveling information of the autonomous vehicle; and a processor configured to: identify a current location of the autonomous vehicle, based on the traveling information and a 3-dimensional first point cloud map of a target area, determine a 2-dimensional global path, which is from the current location to a destination location of the autonomous vehicle, based on a 2.5-dimensional first occupancy grid map, which indicates a global traversability on the target area, generate a 2.5-dimensional second occupancy grid map, which indicates a local traversability that is determined based on a second point cloud map obtained in real-time according to the traveling information, and control the driver by applying a 2-dimensional local path from the current location to the destination location of the autonomous vehicle, to the 2-dimensional global path, based on the second occupancy grid map.

The sensor includes an inertial measurement unit (IMU) and a 3-dimensional light detection and ranging (LiDAR), and the processor may obtain angular velocity information and acceleration information of the autonomous vehicle, from the inertial measurement unit according to traveling of the autonomous vehicle, and obtain a point cloud from the 3-dimensional LiDAR.

The processor may match the traveling information including the point cloud with the first point cloud map according to a normal distribution conversion, and correct matched information based on the traveling information including the angular velocity information and the acceleration information, by using an unscented Kalman filter (UKF), identify a 3-dimensional location of the autonomous vehicle.

The processor may identify the current location of the autonomous vehicle by orthogonally projecting the 3-dimensional location of the autonomous vehicle onto 2-dimensions.

The processor may orthogonally project the second point cloud map from 3-dimensions to 2-dimensions having height information and determine a local traversabiliy of the current location of the autonomous vehicle.

The processor may identify a real-time traveling path by applying the 2-dimensional local path to the 2-dimensional global path, and control the driver to follow the real-time traveling path.

The first point cloud map may be generated by accumulating the point cloud obtained by the autonomous vehicle while traveling in the target area.

The first occupancy grid map may be generated by orthogonally projecting the first point cloud map from 3-dimensions to 2-dimensions having height information, and indicating the global traversability of the target area.

In a method for autonomous traveling performed by an autonomous vehicle according to an embodiment of the present disclosure, the method may include identifying a current location of an autonomous vehicle based on traveling information and a 3-dimensional first point cloud map of a target area; determining a 2-dimensional global path, which is from the current location to a destination location of the autonomous vehicle based on a 2.5-dimensional first occupancy grid map, which indicates a global traversability on the target area; generating a 2.5-dimensional second occupancy grid map, which indicates a local traversability that is determined based on a second point cloud map obtained in real-time according to the traveling information; and controlling the autonomous vehicle to move by applying a 2-dimensional local path from the current location to the destination location of the autonomous vehicle to the 2-dimensional global path based on the second occupancy grid map.

Before the identifying a current location, the method may include obtaining angular velocity information and acceleration information of the autonomous vehicle, from an inertial measurement unit (IMU), while the autonomous vehicle is traveling; and obtaining a point cloud from a 3-dimensional light detection and ranging (LiDAR).

The identifying the current location may comprise matching the traveling information including the point cloud with the first point cloud map according to a normal distribution conversion, and correcting the matched information based on the traveling information including the angular velocity information and the acceleration information by using an unscented Kalman filter (UKF), identifying the 3-dimensional location of the autonomous vehicle.

The identifying the current location may include identifying the current location of the autonomous vehicle by orthogonally projecting a 3-dimensional location of the autonomous vehicle onto 2-dimensionals.

The generating the second occupancy grid map may include orthogonally projecting the second point cloud map from 3-dimensions to 2-dimensions having height information and determining the local traversability of the current location of the autonomous vehicle.

The controlling the autonomous vehicle may include identifying a real-time traveling path by applying the 2-dimensional local path to the 2-dimensional global path, and controlling the autonomous vehicle to follow the real-time traveling.

The method may further include generating the first point cloud map by performing, accumulating accumulating a point cloud obtained by the autonomous vehicle while the autonomous vehicle is traveling in the target arca.

The method may further include generating the first occupancy grid map by performing, orthogonally projecting the first point cloud map from 3-dimensions to 2-dimensions having height information, and indicating the global traversability of the target area.

In an autonomous system according to an embodiment of the present disclosure, there is provided an autonomous vehicle including: a driver configured to control driving of the autonomous vehicle; a sensor configured to obtain traveling information of the autonomous vehicle; and a processor configured to identify a current location of the autonomous vehicle based on the traveling information and a 3-dimensional first point cloud map of a target area, determine a 2-dimensional global path, which is from the current location to a destination location of the autonomous vehicle based on a 2.5-dimensional first occupancy grid map, which indicates a global traversability on the target, generate a 2.5-dimensional second occupancy grid map, which indicates a local traversability that is determined based on a second point cloud map obtained in real-time according to the traveling information, and control the driver by applying a 2-dimensional local path from the current location to the destination location of the autonomous vehicle to the 2-dimensional global path based on the second occupancy grid map; and a server configured to generate the first point cloud map and the first occupancy grid map and transfer them to the autonomous vehicle.

The autonomous vehicle may orthogonally project the second point cloud map from 3-dimensions to 2-dimensions having height information and determine a local traversabiliy of the current location of the autonomous vehicle.

The server may receive a point cloud obtained by the autonomous vehicle while the autonomous vehicle is traveling in the target area, and accumulate the point cloud to generate the first point cloud map.

The server may orthogonally project the first point cloud map from 3-dimensions to 2-dimensions having height information and indicate the determined global traversability for the target area to generate the first occupancy grid map.

According to an embodiment of the present disclosure, a real-time traveling path reflecting an outdoor environment can be more precisely set based on 2.5-dimensional information, and safe autonomous traveling can be performed.

According to an embodiment of the present disclosure, a basic framework that serves as the basis for an outdoor autonomous traveling service that increases the calculation speed of the traveling path and optimizes the amount of calculation can be distributed.

According to an embodiment of the present disclosure, a framework applicable to all outdoor autonomous vehicles regardless of the type of autonomous vehicle can be provided based on only the traveling information.

### BRIEF DESCRIPTION OF THE DRAWINGS

FIG. 1 is a schematic diagram showing an autonomous system according to an embodiment of the present disclosure.

FIG. 2 is a block diagram showing a configuration of the autonomous vehicle according to an embodiment of the present disclosure.

FIG. 3 is a diagram showing an operation flowchart of an autonomous vehicle according to an embodiment of the present disclosure.

FIG. 4 is a diagram showing a framework of an autonomous system according to an embodiment of the present disclosure.

FIG. 5 is a diagram showing an orthogonally projected view according to an embodiment of the present disclosure

FIG. 6 is a diagram showing a view of identifying a current location of the autonomous vehicle according to an embodiment of the present disclosure.

FIG. 7 is a diagram showing a view of determining traversability according to an embodiment of the present disclosure.

### DETAILED DESCRIPTION OF THE EMBODIMENTS

Hereinafter, preferred embodiments according to the present disclosure will be described in detail with reference to the accompanying drawings. The detailed description to be disclosed below along with the accompanying drawings is intended to describe an exemplary embodiment of the present disclosure, and is not intended to represent the only embodiment in which the present disclosure may be implemented. In the drawings, parts irrelevant to the description may be omitted to clearly explain the present disclosure, and the same reference numerals may be used for the same or similar components throughout the specification.

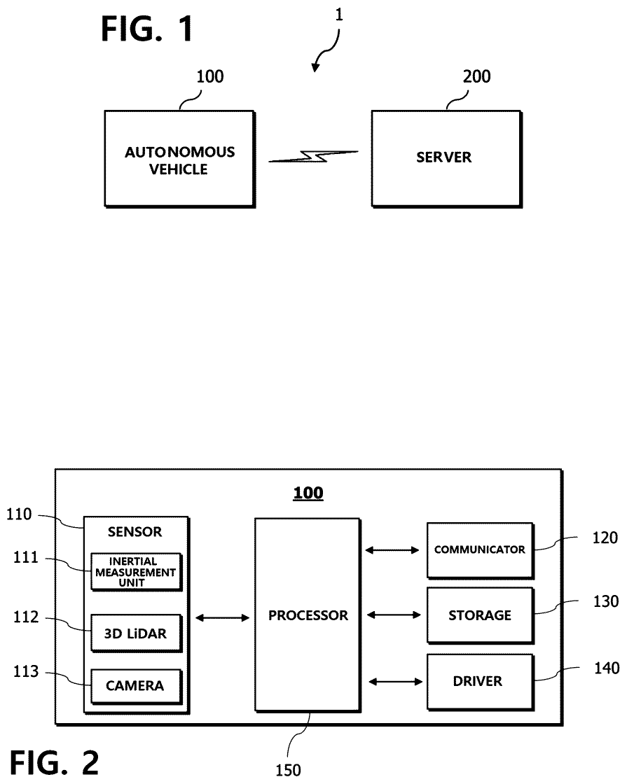

FIG. 1 is a schematic diagram showing an autonomous system according to an embodiment of the present disclosure.

The autonomous system 1 (hereinafter, referred to as a system 1) according to an embodiment of the present disclosure may include an autonomous vehicle 100 and a server 200.

The autonomous vehicle 100 is a device that autonomously drives a target area, and may be implemented as an autonomous robot, an autonomous car, and the like, and other mobile devices that may autonomously travel may be applied without limitation.

The server 200 is a device that provides information necessary for the traveling of the autonomous vehicle 100 through wireless communication, and may be implemented as a computer, a smart phone, a tablet PC, a smart pad, a laptop, and the like as well as a server.

The present disclosure proposes an autonomous vehicle that may perform autonomous traveling more precisely and smoothly even outdoors, and an autonomous driving method using the same.

Hereinafter, the configuration and operation of the autonomous vehicle 100 according to an embodiment of the present disclosure will be described in detail with reference to the drawings.

FIG. 2 is a block diagram showing a configuration of the autonomous vehicle according to an embodiment of the present disclosure.

The autonomous vehicle 100 according to an embodiment of the present disclosure may include a sensor 110, a communicator 120, a storage 130, a driver 140, and a processor 150.

The sensor 110 may be configured as a device that measures traveling information of the autonomous vehicle 100 in real-time, and may include an inertial measurement unit (IMU) 111, a 3-dimensional LiDAR 112, and a camera 113. In addition to this, the sensor 110 may be equipped with various position sensors, such as a global navigation satellite system (GNSS) sensor, an ultrasonic sensor, and a laser sensor.

The inertial measurement unit 111 may obtain acceleration information and angular velocity information of the autonomous vehicle 100, and the 3-dimensional LiDAR 112 may obtain a point cloud for a surrounding environment of the autonomous vehicle 100. In addition, the camera 113 may obtain an image captured by photographing the surrounding environment of the autonomous vehicle 100.

The communicator 120 may perform communication with an external device such as the server 200 and a user terminal to transfer and receive a 3-dimensional point cloud map for a target area, a 2.5-dimensional occupancy grid map where global traversability is determined, a 2.5-dimensional occupancy grid map where local traversability is determined, a current location and a destination location of an autonomous vehicle, a traveling image, a global path, a local path, a traveling path, and the like,

To this end, the communicator 120 may perform wireless communication such as 5th generation communication (5G), long term evolution-advanced (LTE-A), long term evolution (LTE), wireless fidelity (Wi-Fi), Bluetooth, or wired communication such as local area network (LAN), wide area network (WAN), and power line communication.

The storage 130 stores operation programs of the autonomous vehicle 100. The storage 130 includes a non-volatile attribute storage capable of storing data (information) regardless of whether a power source is provided or not, and a volatile attribute memory in which data to be processed by the processor 150 is loaded and the data may not be stored if the power source is not provided. The storage includes flash memory, hard-disc drive (HDD), solid-state drive (SSD), read only memory (ROM), and the memory includes a buffer, random access memory (RAM), and the like.

The storage 130 may store a three-dimensional point cloud map for the target area, a 2.5-dimensional occupancy grid map where global traversability is determined, a 2.5-dimensional occupancy grid map where local traversability is determined, a current location and a destination location of the autonomous vehicle, a driving image, a global path, a local path, a traveling path, and the like, and may store a calculation program necessary in the process of identifying the current location of the autonomous vehicle, setting the global path and the local path, determining the local traversability, and controlling the driver, and the like,

The driver 140 is a configuration necessary for the autonomous vehicle 100 to move along the set traveling path, and may include a motor for speed control, a steering device for steering control, and a braking device for braking control, and the like.

The processor 150 may control at least one other component (e.g., a hardware or software component) of the autonomous vehicle 100 by executing software such as a program, and may perform various data processing or calculations.

The processor 150 according to an embodiment of the present disclosure may identify a current location of an autonomous vehicle using the traveling information and a 3-dimensional first point cloud map for a target area, set a two-dimensional global path from the current location to a destination location of the autonomous vehicle using a 2.5-dimensional first occupancy grid map where global traversability for the target area is determined, generate a 2.5-dimensional second occupancy grid map where local traversability is determined using a second point cloud map obtained in real-time according to the traveling information, and control the driver by reflecting a 2-dimensional local path from the current location to the destination location of the autonomous vehicle to the 2-dimensional global path using the second occupancy grid map.

Meanwhile, the processor 150 may perform at least a part of data analysis, processing, and result information generation for performing the operations using at least one of machine learning, a neural network, or a deep learning algorithm as a rule-based or an artificial intelligence algorithm. Examples of the neural network may include models such as Convolutional Neural Network (CNN), Deep Neural Network (DNN), and Recurrent Neural Network (RNN),

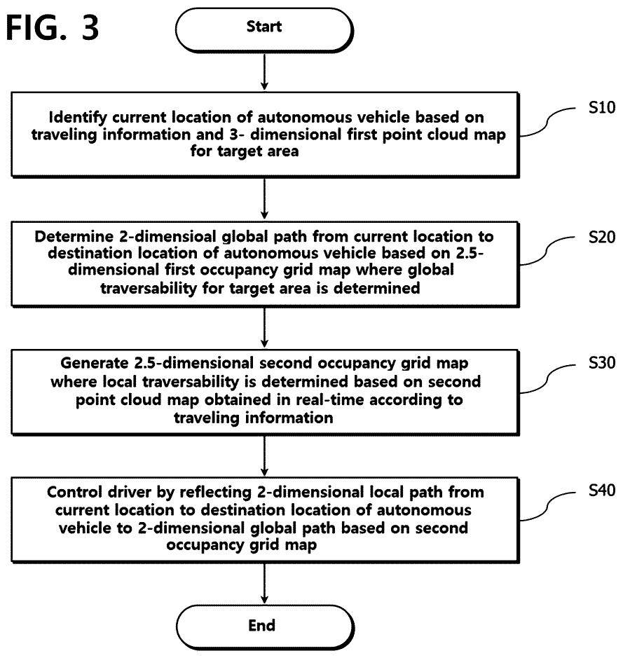

FIG. 3 is a diagram showing an operation flowchart of an autonomous vehicle according to an embodiment of the present disclosure.

A processor 150 according to an embodiment of the present disclosure may identify a current location of an autonomous vehicle 100 using traveling information and a 3-dimensional first point cloud map for a target area (step S10).

The traveling information refers to information measured by the autonomous vehicle 100 through a sensor 110 during the traveling process. The processor 150 may obtain angular velocity information and acceleration information from an inertial measurement unit 111 and obtain a point cloud from a 3-dimensional LiDAR 112 according to the traveling of the autonomous vehicle 100.

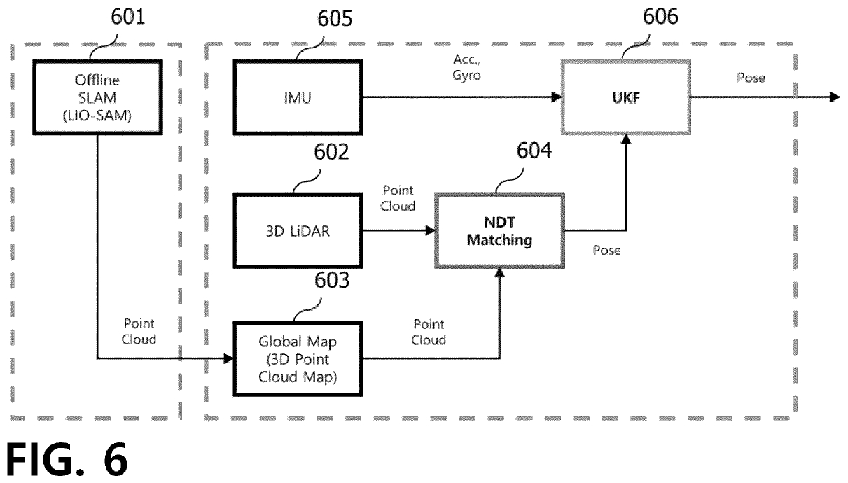

The process of identifying the current location of the autonomous vehicle 100 is a major process that is basic to setting the traveling path, and will be described in detail with reference to FIG. 6.

In this case, the first point cloud map may be a map generated by accumulating the point cloud obtained from the 3-dimensional LiDAR 112 while the autonomous vehicle 100 travels in the target area, and be constructed in advance to determine the global traversability of the autonomous vehicle 100 in the target area. The first point cloud map may be generated using a 3-dimensional simultaneous localization and mapping (SLAM) algorithm with the accumulated point cloud.

The entity that generates the first point cloud map may be any one, but for convenience of the following description, it is assumed that the server 200 performs.

The processor 150 may receive the first point cloud map from the server 200 through the communicator 120, and the reception path of the first point cloud is not limited to any one.

In the present disclosure, 3-dimensional information is used to reflect the outdoor environment of the target area, but since a large amount of computation is required when the 3-dimensional information is used as it is, the 3-dimensional information is projected and used in 2-dimensions having height information, that is, 2.5 dimensions,

For example, the processor 150 may localize the current location of the autonomous vehicle 100 using the traveling information and the 3-D first point cloud map, and in this case, the current location is considered to be a 2-dimensional orthogonal projection of the three-dimensional location of the autonomous vehicle 100 previously localized.

The processor 150 according to an embodiment of the present disclosure may determine the 2-dimensional global path from the current location to the destination location of the autonomous vehicle 100 using the 2.5-dimensional first occupancy grid map where the global traversability for the target area is determined (step S20).

The global traversability is a result of determining whether the autonomous vehicle 100 is traveling on a global arca or not (non-traveling). Hereinafter, the occupancy grid map indicating whether there is the global traversability in the target area is referred to as a first occupancy grid map.

Specifically, the first occupancy grid map may be generated by orthogonally projecting the first point cloud map in the 2D having height information in the 3D, and indicating the global traversability determined for the target arca.

At this time, it is sufficient that the global traversability is indicated on the occupancy grid map to distinguish a travelable area from a non-travelable area, and the indicating method or map type thereof is not limited to any one,

Meanwhile, the first occupancy grid map may also be previously constructed similarly to the first point cloud map, and any entity that also generates the first occupancy grid map may be considered to be performed by the server 200 for convenience of the following description.

The processor 150 may set a 2-dimensional global path from the current location to the destination location of the autonomous vehicle 100 based on the travelable area indicated in the first occupancy grid map. In this case, the processor 150 may set the shortest distance from the current location to the destination location as a 2-dimensional global path. The processor 150 may receive information about the destination location from the server 200,

The processor 150 according to an embodiment of the present disclosure may generate a 2.5-dimensional second occupancy grid map where the local traversability is determined using a second point cloud map obtained in real-time according to the traveling information (step S30).

Meanwhile, as discussed above, in the step S20, the traversability of the autonomous vehicle 100 is not determined in real-time, but is determined using a pre-constructed point cloud map and an occupancy grid map. Therefore, it is necessary to reflect the driving environment, such as obstacles that appear randomly in real-time at the actual traveling time.

The processor 150 may generate a second point cloud map using the point cloud obtained in real-time from the 3-dimensional LiDAR 112.

The processor 150 may orthogonally project the second point cloud map from 3-dimensions to 2-dimensions having height information, and determine local traversability for the current location of the autonomous vehicle 100. Hereinafter, the occupancy grid map indicating whether there is the local traversability in the target area is referred to as a second occupancy grid map.

The processor 150 according to an embodiment of the present disclosure may control the driver 140 by reflecting the 2-dimensional local path from the current location to the destination location of the autonomous vehicle 100 to the 2-dimensional global path using the second occupancy grid map (step S40).

The processor 150 may identify the 2-dimensional local path from the current location to the destination location of the autonomous vehicle 100 using the second occupancy grid map. The 2-dimensional local path is determined according to a real-time current location according to the traveling of the autonomous vehicle 100 and the local traversability at the corresponding location, and the 2-dimensional global path may be modified by the 2-dimensional local path.

For example, if the autonomous vehicle 100 finds an obstacle while traveling on a 2-dimensional global path, a 2-dimensional local path may be generated in a direction of avoiding the obstacle.

The processor 150 may identify the real-time traveling path by reflecting the 2-dimensional local path to the 2-dimensional global path and control the driver 140 to follow the real-time traveling path.

According to an embodiment of the present disclosure, by using 2.5-dimensional information, a real-time traveling path may be set that reflects the outdoor environment more precisely, and safe autonomous traveling may be performed.

According to an embodiment of the present disclosure, it is possible to distribute a basic framework that serves as the basis for outdoor autonomous traveling services that increases the calculation speed of traveling paths and optimizes the amount of calculation.

According to an embodiment of the present disclosure, it is possible to provide a framework applicable to all outdoor autonomous vehicles regardless of the type of autonomous vehicle only by traveling information (acceleration information, angular velocity information, and point cloud).

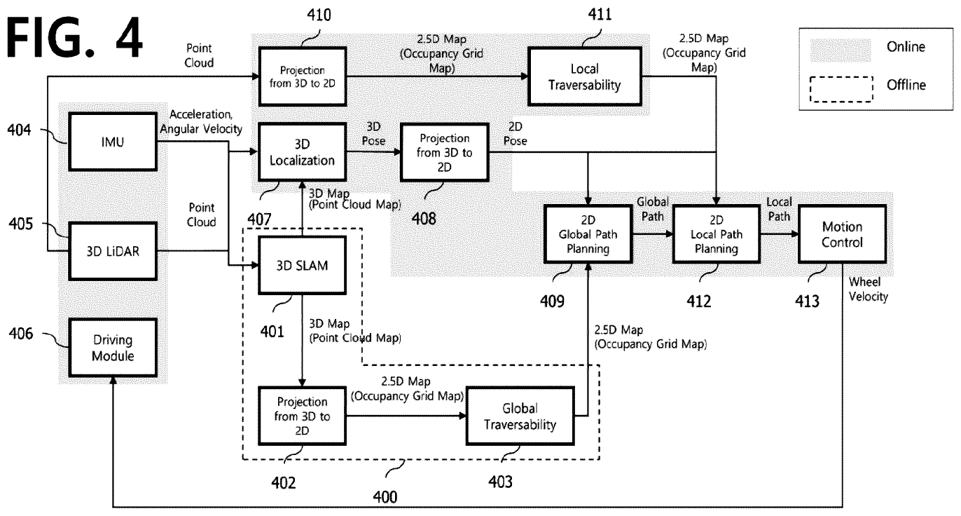

FIG. 4 is a diagram showing a framework of an autonomous system according to an embodiment of the present disclosure.

Referring to FIG. 4, the framework of the autonomous system I may be largely divided into two parts, an offline part and an online part. In this case, the contents of the framework overlap with the operation flow of the autonomous vehicle 100 described with reference to FIG. 3, and the overlapping contents will not be described in detail.

The offline part 400 is a pre-work part for traveling the autonomous vehicle 100, and the remaining online parts except for the offline part 400 in FIG. 4 may be viewed as parts that are performed in real-time according to the traveling of the autonomous vehicle 100. In this case, the offline part 400 may be performed by the server 200 as described above,

First, referring to the offline part 400, a 3-dimensional first point cloud map for a target area may be generated (referring to 401), the 3-dimensional first point cloud map may be orthogonally projected into 2-dimensions having height information (referring to 402), and a first occupancy grid map may be generated by determining a global traversability (referring to 403).

In the online part, the autonomous vehicle 100 may obtain acceleration information and angular velocity information using an inertial measurement unit (referring to 404), and a point cloud may be obtained using a 3-dimensional LiDAR (referring to 405). The autonomous vehicle 100 may control a driver according to a path setting process to be described later (referring to 406).

The autonomous vehicle 100 may identify a 3-dimensional location of the autonomous vehicle 100 using the obtained traveling information including the acceleration information, the angular velocity information, and the point cloud, and a first point cloud (referring to 407).

Thereafter, the autonomous vehicle 100 may project the identified 3-dimensional location into 2-dimensions (referring to 408), and a global path between the current location and the destination location may be set using the first occupancy grid map (referring to 409).

Meanwhile, the autonomous vehicle 100 may orthogonally project the point cloud obtained from the 3-dimensional LiDAR from 3-dimensions in 2-dimensions having height information (referring to 410), and generate a second occupancy grid map by determining local traversability (referring to 411).

The autonomous vehicle 100 may set a local path using the generated global path and the second occupancy grid map (referring to 412), and may control the driver 140 of the autonomous vehicle 100 along the set traveling path (referring to 413).

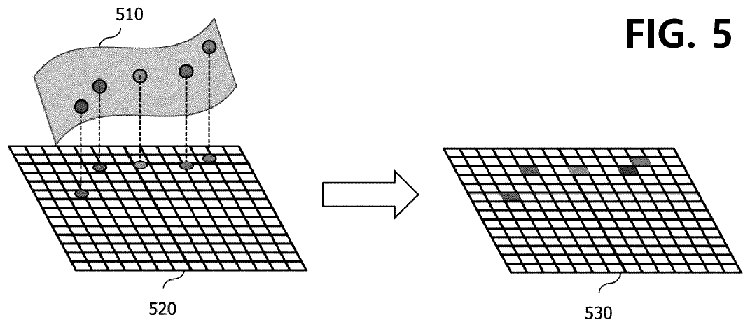

FIG. 5 is a diagram showing an orthogonally projected view according to an embodiment of the present disclosure.

The autonomous vehicle 100 may project the 3-dimensional information 510, for example, the point cloud, and the 3-dimensional location of the autonomous vehicle 100 onto the 2-dimensional occupancy grid map 520.

In this case, in order to reflect the outdoor high and low environment, the autonomous vehicle 100 may generate a 2.5-dimensional occupancy grid map 530 by projecting the height information of the 3-dimensional information 510.

FIG. 6 is a diagram showing a view of identifying a current location of the autonomous vehicle according to an embodiment of the present disclosure.

FIG. 6 shows a process of identifying a current location of the autonomous vehicle 100 as described above with reference to step S10 of FIG. 3.

The autonomous vehicle 100 may receive the 3-dimensional first point cloud map obtained in the offline part. The first point cloud map may be obtained using a three-dimensional SLAM algorithm, in particular, the LIO-SAM algorithm (referring to 601).

The autonomous vehicle 100 may match the traveling information 602 including the point cloud with the first point cloud map 603 according to the normal distribution transformation (NDT) (referring to 604).

The formula for the normal distribution transformation is as follows.

$${f}_{R , t} ( x ) = Rx + t \qquad Equation 1$$

Equation 1 is a formula for calculating scan data (f_{R,f}(x)) acquired when time is t, where R is a rotation transformation matrix, x is scan data acquired when time is t+1, and t represents translation.

$$arg {min}_{R , t} \{ - {\sum }_{i} NDT ( {f}_{R , t} ( {x}_{i} ) ) \} \qquad Equation 2$$

Equation 2 is a formula that optimizes the cost function of the normal distribution transformation map (NDT(f_{R,t}(xi)).

The autonomous vehicle 100 may identify the 3-dimensional location of the autonomous vehicle 100 by correcting the matched information (referring to 604) according to the traveling information including angular velocity information and acceleration information (referring to 605) using the Unscented Kalman Filter (UKF) (referring to 606).

Non-linear function prediction is possible using unscented transformation, and accurate estimation of the location of an autonomous vehicle 100 is possible by predicting the non-linear function itself.

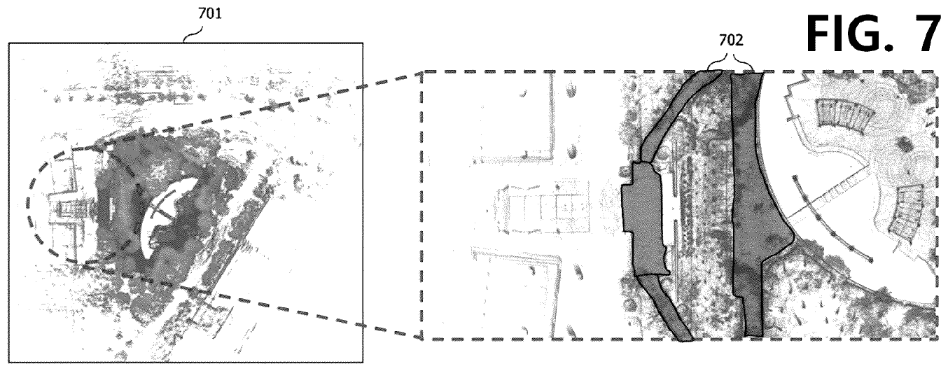

FIG. 7 is a diagram showing a view of determining traversability according to an embodiment of the present disclosure.

FIG. 7 shows a first point cloud map 701 for a certain target area.

The server 200 may determine whether the generated first point cloud map 701 has global traversability, and perform a labeling operation to indicate the traversable path 702.

Specifically, the server 200 may receive a point cloud obtained by the autonomous vehicle while traveling in the target area, accumulate the point cloud, and generate the first point cloud map 701.

The server 200 may orthogonally project the first point cloud map 701 from 3-dimensions to 2-dimensions having height information, and indicate the global traversability determined for the target area to generate a first occupancy grid map.

What is claimed is:

1. An autonomous vehicle comprising:
a driver configured to control driving of the autonomous vehicle;
a sensor configured to obtain traveling information of the autonomous vehicle; and
a processor configured to:
identify a current location of the autonomous vehicle, based on the traveling information and a 3-dimensional first point cloud map of a target area,
determine a 2-dimensional global path, which is from the current location to a destination location of the autonomous vehicle, based on a 2.5-dimensional first occupancy grid map, which indicates a global traversability on the target area,
generate a 2.5-dimensional second occupancy grid map, which indicates a local traversability that is determined based on a second point cloud map obtained in real-time according to the traveling information, and
control the driver by applying a 2-dimensional local path from the current location to the destination location of the autonomous vehicle, to the 2-dimensional global path, based on the second occupancy grid map.

2. The autonomous vehicle of claim 1, wherein the sensor comprises:
an inertial measurement unit (IMU); and
a 3-dimensional light detection and ranging (LiDAR), and
the processor is further configured to:
obtain angular velocity information and acceleration information of the autonomous vehicle, from the IMU according to traveling of the autonomous vehicle, and
obtain a point cloud from the 3-dimensional LiDAR.

3. The autonomous vehicle of claim 2, wherein the processor is further configured to:
match the traveling information including the point cloud, with the first point cloud map, according to a normal distribution conversion,
correct matched information, based on the traveling information including the angular velocity information and the acceleration information, by using an unscented Kalman filter (UKF), and
identify a 3-dimensional location of the autonomous vehicle.

4. The autonomous vehicle of claim 3, wherein the processor is further configured to:
identify the current location of the autonomous vehicle, by orthogonally projecting the 3-dimensional location of the autonomous vehicle onto 2-dimensions.

5. The autonomous vehicle of claim 1, wherein the processor is further configured to:
orthogonally project the second point cloud map from 3-dimensions to 2-dimensions having height information; and
determine a local traversabiliy of the current location of the autonomous vehicle.

6. The autonomous vehicle of claim 1, wherein the processor is further configured to:
identify a real-time traveling path, by applying the 2-dimensional local path to the 2-dimensional global path; and
control the driver to follow the real-time traveling path.

7. The autonomous vehicle of claim 2, wherein the first point cloud map is generated by:
accumulating the point cloud obtained by the autonomous vehicle while traveling in the target area.

8. The autonomous vehicle of claim 7, wherein the first occupancy grid map is generated by:
orthogonally projecting the first point cloud map from 3-dimensions to 2-dimensions having height information; and
indicating the global traversability of the target area.

9. A method for autonomous traveling performed by an autonomous vehicle, the method comprising:
identifying a current location of the autonomous vehicle based on traveling information and a 3-dimensional first point cloud map of a target area;
determining a 2-dimensional global path, which is from the current location to a destination location of the autonomous vehicle, based on a 2.5-dimensional first occupancy grid map, which indicates a global traversability on the target area;
generating a 2.5-dimensional second occupancy grid map, which indicates a local traversability that is determined based on a second point cloud map obtained in real-time according to the traveling information; and
controlling the autonomous vehicle to move by applying a 2-dimensional local path from the current location to the destination location of the autonomous vehicle, to the 2-dimensional global path based on the second occupancy grid map.

10. The method of claim 9, wherein before the identifying a current location, the method comprises:
obtaining angular velocity information and acceleration information of the autonomous vehicle, from an inertial measurement unit (IMU), while the autonomous vehicle is traveling; and
obtaining a point cloud from a 3-dimensional light detection and ranging (LiDAR).

11. The method of claim 10, wherein the identifying the current location comprises:
matching the traveling information including the point cloud, with the first point cloud map, according to a normal distribution conversion;
correcting the matched information, based on the traveling information including the angular velocity information and the acceleration information, by using an unscented Kalman filter (UKF); and
identifying the 3-dimensional location of the autonomous vehicle.

12. The method of claim 11, wherein the identifying the current location comprises:
identifying the current location of the autonomous vehicle, by orthogonally projecting a 3-dimensional location of the autonomous vehicle onto 2-dimensionals.

13. The method of claim 9, further comprising:
generating the second occupancy grid map, by performing:
orthogonally projecting the second point cloud map from 3-dimensions to 2-dimensions having height information; and
determining the local traversability of the current location of the autonomous vehicle.

14. The method of claim 9, wherein the controlling the autonomous vehicle comprises:
identifying a real-time traveling path by applying the 2-dimensional local path to the 2-dimensional global path; and
controlling the autonomous vehicle to follow the real-time traveling path.

15. The method of claim 9, further comprising:
generating the first point cloud map by performing:
accumulating a point cloud obtained by the autonomous vehicle while the autonomous vehicle is traveling in the target area.

16. The method of claim 15, further comprising:
generating the first occupancy grid map by performing:
orthogonally projecting the first point cloud map from 3-dimensions to 2-dimensions having height information; and
indicating the global traversability of the target area.

17. An autonomous system comprising:
an autonomous vehicle comprising:
a driver configured to control driving of the autonomous vehicle;
a sensor configured to obtain traveling information of the autonomous vehicle; and
a processor configured to:
identify a current location of the autonomous vehicle based on the traveling information and a 3-dimensional first point cloud map of a target area,
determine a 2-dimensional global path, which is from the current location to a destination location of the autonomous vehicle based on a 2.5-dimensional first occupancy grid map, which indicates a global traversability on the target area,
generate a 2.5-dimensional second occupancy grid map, which indicates a local traversability that is determined based on a second point cloud map obtained in real-time according to the traveling information, and
control the driver by applying a 2-dimensional local path from the current location to the destination location of the autonomous vehicle to the 2-dimensional global path based on the second occupancy grid map; and
a server configured to generate the first point cloud map and the first occupancy grid map, and transfer them to the autonomous vehicle.

18. The autonomous system of claim 17, wherein the autonomous vehicle is further configured to:
orthogonally project the second point cloud map from 3-dimensions to 2-dimensions having height information; and
determine a local traversabiliy of the current location of the autonomous vehicle.

19. The autonomous system of claim 17, wherein the server is further configured to:
receive a point cloud obtained by the autonomous vehicle while the autonomous vehicle is traveling in the target area; and
accumulate the point cloud to generate the first point cloud map.

20. The autonomous system of claim 17, wherein the server is configured to:
orthogonally project the first point cloud map from 3-dimensions to 2-dimensions having height information; and
indicate the determined global traversability for the target area to generate the first occupancy grid map.
